(19) United States
(12) Patent Application Publication
(10) Pub. No.: US 2005/0044508 A1
(43) Pub. Date: Feb. 24, 2005

(54) Method, system and program product for customizing a user interface

(75) Inventor: Marcia L. Stockton, Bakersfield, CA (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/645,057

(22) Filed: Aug. 21, 2003

(51) Int. Cl. G09G 5/00

(52) U.S. Cl. 715/811; 715/745; 715/789; 715/825; 715/788

(57) ABSTRACT

Method, system and program product for customizing a user interface. A group of users of the application can be defined. For each user in the group, a use count for one or more user interface elements is recorded. The recorded use counts can be used to calculate a use weight for the group of users, which is then used to modify the corresponding user interface element.

### BACKGROUND OF THE INVENTION

1. Technical Field

The invention generally relates to customizing a user interface, and more specifically, to customizing one or more user interface elements based on use of the underlying application by a group of users.

2. Background Art

The user interface of an application generally is configured in advance of distribution according to a “best guess” of the developer. For example, the configuration of various aspects of the user interface such as menus, icons, etc. are arranged in a particular order that is intended to make the most commonly selected elements more readily accessible to the user. However, the actual usage patterns of a group of users may differ from the “best guess” of the developer. This can lead to inefficient use of the application, and frustration on the part of the users.

To date, solutions that seek to address this problem require that a user and/or developer manually configure one or more of the user interface elements. For example, the user can add and remove icons that appear on a toolbar. However, many users are not aware of this capability. Further, since these operations are infrequently performed by the user, users often have to releam how to perform the customizations. Still yet, the developer could rearrange the default location of elements in a user interface to best suit the users. However, performing such a task is both time-consuming and expensive, and may require that the application be redistributed. As a result, current solutions are both underutilized and inefficient.

In light of this, a need exists for a method, system and program product for customizing a user interface. In particular, a need exists for a solution that allows one or more user interface elements to be modified based on the usage by a group of users.

### SUMMARY OF THE INVENTION

The invention provides a method, system and program product for customizing a user interface. Specifically, under the present invention, one or more “user interface elements” can be modified (e.g., repositioned or enhanced). A user interface element can comprise any element of a user interface that can be independently modified. For example, a user interface element can comprise an icon on a toolbar, an item in a menu, a button on a display, etc. In any event, a group of users is defined for which the user interface element(s) will be modified. For each user interface element, a “use count” is recorded each time a user in the group of users selects the user interface element. A “use weight” for the user interface element can then be calculated using the recorded use counts for each user. Each user interface element can be modified based on the calculated use weight. As a result, the invention provides a solution for customizing a user interface for a group of users.

A first aspect of the invention provides a method of customizing a user interface, the method comprising: recording a use count for a user interface element for each user in a group of users; obtaining a use weight for the user interface element based on the use counts for the group of users; and modifying the user interface element for each user in the group of users based on the use weight.

A second aspect of the invention provides a method of customizing a user interface, the method comprising: defining a group of users to include a plurality of users; associating a server with the group of users; obtaining a use count for a user interface element for each user in the group of users at the server; calculating a use weight for the user interface element based on the use counts for the group of users at the server; and modifying the user interface element for each user in the group of users based on the use weight.

A third aspect of the invention provides a system for customizing a user interface, the system comprising: a definition system for defining the group of users; a communication system for obtaining a use count for a user interface element for each user in a group of users; and a calculation system for calculating a use weight for the user interface element based on the use counts for the group of users.

A fourth aspect of the invention provides a program product stored on a recordable medium for customizing a user interface, which when executed comprises: program code for defining the group of users; program code for obtaining a use count for a user interface element for each user in a group of users; and program code for calculating a use weight for the user interface element based on the use counts for the group of users.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative system for customizing a user interface according to one embodiment of the invention;

FIG. 2 shows an illustrative data flow between the systems shown in FIG. 1;

FIG. 3 shows illustrative method steps performed on a server according to another embodiment of the invention; and

FIG. 4 shows illustrative method steps performed on a user device according to still another embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a method, system and program product for customizing a user interface. Specifically, under the present invention, one or more user interface elements can be modified. A user interface element can comprise any elements of a user interface that can be independently modified. For example, a user interface element can comprise an icon on a toolbar, an item in a menu, a button on a display, etc. A group of users is defined for which the user interface element(s) will be modified. For each user interface element, a use count is recorded each time a user in the group of users selects the user interface element. A use weight for the user interface element can be calculated using the recorded use counts for each user. Each user interface element can be modified based on the calculated use weight. As a result, the invention provides a solution for customizing a user interface for a group of users.

In one embodiment of the invention, each user interface element that can be modified is configured to incorporate “use data.” Use data comprises a “use count” and a “use weight.” The use count can comprise the number of times that the particular user interface element has been selected. To this extent, each time the user interface element is selected, the corresponding use count is incremented. The use weight can comprise a likelihood that the user interface element will be selected. The use weight is based on the use counts obtained for the user interface element from the group of users. For example, the use counts for a group of related user interface elements could be summed and compared. The use weight for each user interface element could then be calculated as the percentage of the total selections for the group that were made for each user interface element. The use count and/or use weight can be based on a limited time period, for example, a certain number of days or number of executions of the application.

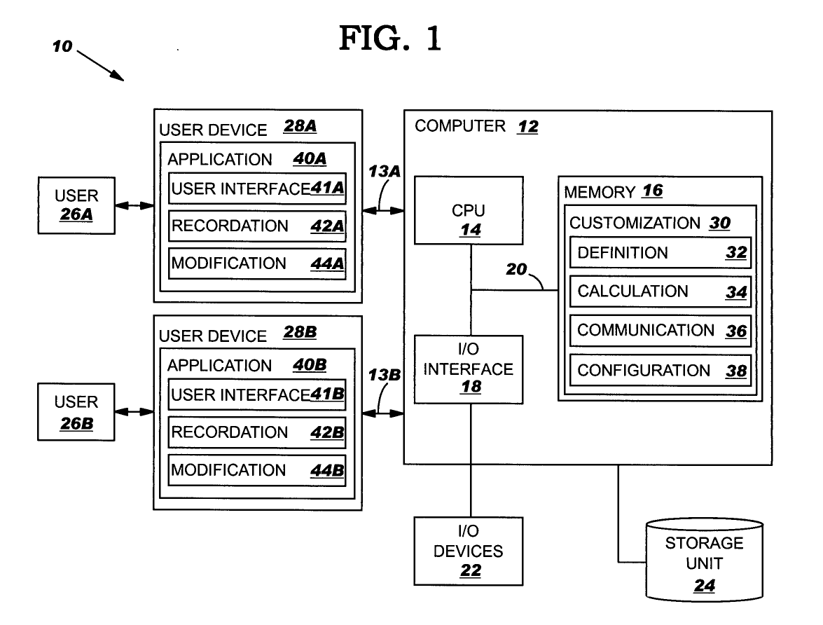

Turning to the drawings, FIG. 1 shows a computerized system 10 for customizing a user interface 41A-B. System 10 includes a computer 12 that communicates with user devices 28A-B over communications links 13A-B, respectively. To this extent, computer 12 and user devices 28A-B each comprise any type of computing device capable of communicating with one or more other computing devices. For example, user devices 28A-B could comprise personal computing devices (e.g., laptop, personal computer, personal digital assistant, cellular phone, pager device, etc.) while computer 12 could comprise a larger-sized computer system (e.g., a workstation, a server, etc.). In any event, users 26A-B use applications 40A-B, respectively, by operating user devices 28A-B. During use, applications 40A-B render user interfaces 41A-B, respectively. The invention allows one or more user interface elements of user interfaces 41A-B to be modified as determined by customization system 30.

Communications links 13A-B can comprise direct hardwired connections (e.g., serial port) or network connections. In the case of the latter, the network can comprise an addressable connection in a client-server (or server-server) environment that may utilize any combination of wireline and/or wireless transmission methods. In this instance, the server and client may utilize conventional network connectivity, such as Token Ring, Ethernet, WiFi or other conventional communications standards. Further, the network can comprise any type of network, including the Internet, a wide area network (WAN), a local area network (LAN), a virtual private network (VPN), etc. Where the client communicates with the server via the Internet, connectivity could be provided by conventional TCP/IP sockets-based protocol, and the client would utilize an Internet service provider to establish connectivity to the server.

As shown, computer 12 generally includes central processing unit (CPU) 14, memory 16, input/output (1/0) interface 18, bus 20, external I/O devices/resources 22, and a storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Storage unit 24 may comprise any type of data storage for providing more static storage of data used in the present invention. As such, storage unit 24 may include one or more storage devices, such as a magnetic disk drive or an optical disk drive. Moreover, similar to CPU 14, memory 16 and/or storage unit 24 may reside at a single physical location, comprising one or more types of data storage, or be distributed across a plurality of physical systems in various forms. To this extent, memory 16 and/or storage unit 24 can include data distributed across, for example, a LAN, WAN or a storage area network (SAN) (not shown).

I/O interface 18 may comprise any system for exchanging information to/from one or more external devices, e.g., I/O devices 22. I/O devices 22 may comprise any known type of external device, including speakers, a CRT, LED screen, handheld device, keyboard, mouse, voice recognition system, speech output system, printer, monitor/display, facsimile, pager, etc. To this extent, it should be appreciated that if computer 12 is a handheld device, the display would be contained within computer 12, and not as an external I/O device 22 as shown. Bus 20 provides a communication link between each of the components in computer 12 and likewise may comprise any known type of transmission link, including electrical, optical, wireless, etc. In addition, although not shown, additional components, such as cache memory, communication systems, system software, etc., may be incorporated into computer 12. It is understood that user devices 28A-B include the same components (e.g., CPU, memory, etc.) as shown and described with reference to computer 12. These components have not been separately shown and discussed for brevity.

Shown in memory 16 is a customization system 30. Customization system 30 is shown including a definition system 32, a calculation system 34, a communication system 36, and a configuration system 38. Further, user devices 28A-B are shown including applications 40A-B that each includes a user interface 41A-B, a recordation system 42A-B and a modification system 44A-B, respectively. Applications 40A-B represent two instances of the same application code (e.g., two installations of the word processing application LOTUS WORD PRO offered by International Business Machines, Inc.). User interface 41A-B is typically provided as part of the underlying application 40A-B.

It will be apparent to one skilled in the art that application 40A-B, and therefore user interface 41A-B, when used within a specific context by a group of users, is likely to be used in different ways than when application 40A-B is used in a different context by a second group of users. For example, application 40A-B can comprise a word processing application that can open many different kinds of files. However, a group of users may generally use application 40A-B to open a specific kind of file that arrives on a specific message queue from a specific back-end application to generate corporate documents. As a second example, application 40A-B could comprise a software development tool that includes functionality to edit source code, compile source code, build executable modules, and check files into and out of a source code library. However, a group of users that performs only software maintenance may only use application 40A-B for debugging the source code. In either case, the invention can exploit these unique uses by automatically customizing user interface 41A-B for each user 26A-B in the group of users in a similar manner based on the group's use of application 40A-B.

In general, system 10 customizes one or more user interface elements of user interface 41A-B based on use data for a group of users 26A-B. More particularly, configuration system 38 can configure one or more user interface elements of user interface 41 A-B to incorporate use data. Definition system 32 can define the group of users for which use counts of the one or more user interface elements will be recorded by recordation system 42A-B at each user device 28A-B. Communication system 36 can obtain the recorded use counts from each user device 28A-B, and calculation system 34 can process the use counts to calculate a use weight. Communication system 36 can communicate the use weight to each user device 28A-B, and modification system 44A-B can modify the user interface element based on the use weight. It is understood that application 40A-B and/or user interface 41A-B can comprise any existing software product or the like. In this case, some or all of the functionality discussed herein can supplement the functionality provided by the existing software product.

As previously discussed, communication system 36 can obtain and/or send use data between the various systems located on computer 12 and each user device 28A-B. For example, communication system 36 can request the use counts stored on each user device 28A-B, and then obtain the use counts from each user device 28A-B. Further, communication system 36 can receive a request from a user device 28A-B for a use weight, and communicate the use weight to the requesting user device 28A-B. It is understood that the functionality provided by communication system 36 could be implemented apart from customization system 30 or merged into one or more of the systems shown.

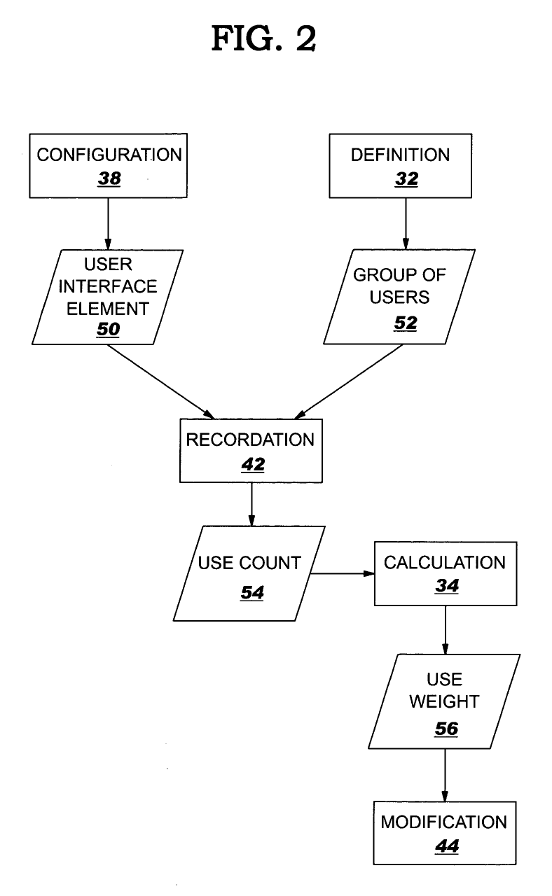

FIG. 2 shows an illustrative data flow between the systems shown in FIG. 1. As discussed, the invention allows one or more user interface elements 50 to be modified based on use data. Configuration system 38 can configure each user interface element 50 of user interface 41A-B (FIG. 1) that is to be modified to incorporate use data. In particular, configuration system 38 configures user interface element 50 to allow the recording of a use count 54 and accept modification based on a use weight 56. For example, each user interface element 50 can be configured to perform some action (e.g., signal that it has been selected) each time it is selected. In one embodiment, configuration system 38 is implemented as part of an environment used to develop user interface 41A-B. Once each of the user interface elements 50 of user interface 41A-B have been configured, user interface 41A-B can be distributed as part of application 40A-B (FIG. 1) for use by users 26A-B (FIG. 1). Distribution of application 40A-B can comprise making it available for public sale, posting it on a web site for downloading, copying it to one or more user devices 26A-B on a company network, etc. In any event, once distributed, each instance of application 40A-B will include a user interface 41A-B that has one or more user interface elements 50 that incorporate use data.

The user interface elements 50 are modified (e.g., repositioned, or otherwise varied in prominence, in user interface 41A-B) based on use data obtained for a group of users 52. Definition system 32 can define the group of users 52. Group of users 52 comprises one or more users 26A-B (FIG. 1) for which use counts 54 are recorded for an user interface element 50 and used to obtain a use weight 56 of the user interface element 50. Various possibilities exist for defining group of users 52. For example, group of users 52 could comprise all managers in a corporation, all employees in a department (e.g., technical support), selected individuals, a group of employees using application 40A-B for a given job function (e.g., purchasing), etc. In any event, when implemented on a client-server network, definition system 32 can also associate group of users 52 with a server (e.g., computer 12 shown in FIG. 1). By associating group of users 52 with a server, each instance of application 40A-B can request data from the associated server as described further below.

During use of user interface 41A-B (FIG. 1) by each user 26A-B (FIG. 1) in group of users 52, a use count 54 can be recorded for each user interface element 50 by recordation system 42. For example, a user interface element 50 can signal recordation system 42 each time it is selected, and recordation system 42 can increment the corresponding use count 54. Recordation system 42 can maintain a separate use count 54 for each user 26A-B in group of users 52. When implemented on a server, recordation system 42 can identify the user 26A-B, and increment the corresponding use counts 54 associated with the identified user 26A-B and stored, for example, in storage unit 24. When implemented on a unique user device 28A-B (FIG. 1) for each user 26A-B, recordation system 42 can store and increment use counts 54 on each user device 28A-B. In any event, each time a user 26A-B selects a user interface element 50, recordation system 42 increments the use count 54 that corresponds to the user 26A-B and user interface element 50 pair.

When implemented on various user devices 28A-B, recordation system 42 can communicate the use counts 54 to the server (e.g., computer 12 (FIG. 1)) associated with the group of users 52 for processing by calculation system 34. Alternatively, calculation system 34 can compile the use counts 54 stored, for example, in storage unit 24 for each user 26A-B (FIG. 1) in group of users 52. In either case, once a use count 54 for a user 26A-B has been obtained by calculation system 34, recordation system 42 can reset the use count 54. Any solution can be implemented to determine when use counts 54 are obtained by calculation system 34. For example, calculation system 34 can periodically (e.g., once a week) request the use counts 54 from each user 26A-B in group of users 52. Alternatively, the use counts 54 can be provided each time a user 26A-B terminates the application 40A-B. Still further, use counts 54 could be provided once a threshold number of executions of application 40A-B have been performed.

Calculation system 34 calculates a use weight 56 for each user interface element 50 based on the use counts 54 obtained for group of users 52. Use weight 56 can comprise any value that indicates a relative frequency and/or probability of the corresponding user interface element 50 being selected within group of users 52. For example, use weight 56 can comprise an unsigned byte (i.e., eight bits) that can have any value from 0-255. A value of 128 could represent a neutral value, i.e., the corresponding user interface element 50 is neither more likely nor less likely to be selected than other user interface elements 50. All use weights 56 can be initially set to this value when application 40A-B is initially distributed. A value greater than 128 could represent a positive likelihood that the corresponding user interface element 50 will be selected, and values less than 128 could represent a negative likelihood that the corresponding user interface element 50 will be selected. Using this system, the greater difference between a value and 128, the more/less likely it is that the user interface element 50 will be selected.

Use weights 56 can be calculated by considering all user interface elements 50 for which use counts 54 are recorded, or only related user interface elements 50. For example, use weights 56 that correspond with each item on a drop-down menu may be calculated versus the other items on the same menu. The use data for the items on a second drop-down menu may be considered independently since the two menus are never simultaneously shown. However, if each user interface element 50 comprises an icon on a toolbar, then the use weights 56 could be calculated versus all the icons since they are displayed as a group.

Use weights 56 are provided to modification system 44, which can modify one or more of the user interface elements 50 based on the corresponding use weight 56. That is, modification system 44 can render a user interface element 50 more accessible when its use weight 56 indicates that it is more likely to be selected. Similarly, modification system 44 can render a user interface element 50 less accessible when its use weight 56 indicates that it is less likely to be selected. As with use counts, any solution can be implemented for determining when new use weights 56 are obtained by modification system 44. For example, each time application 40A-B is executed, the corresponding modification system 44A-B could request updated use weights 56. Alternatively, communication system 36 can periodically broadcast the updated use weights 56 to all user devices 28A-B. In any event, modification system 44 can adjust the size, font, color, location, and/or other characteristic readily discernible by human senses, of each user interface element 50 based on the use weight 56 that corresponds to each user interface element 50.

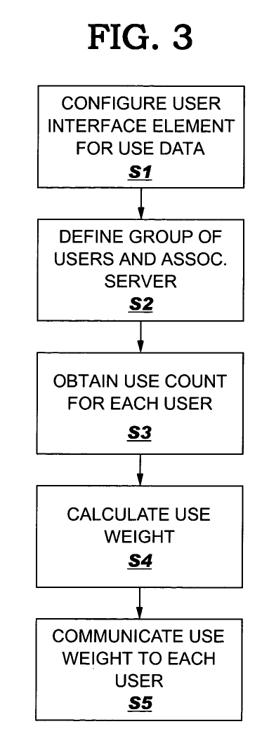

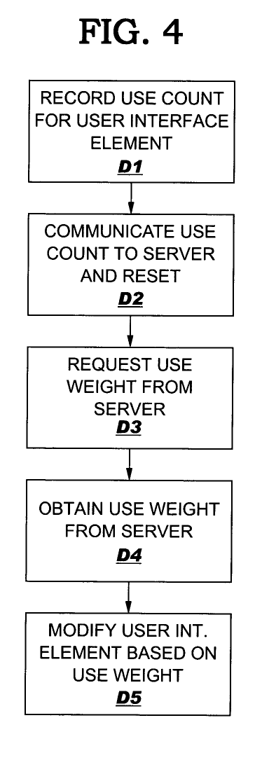

As previously discussed, system 10 shown in FIG. 1 can comprise a client-server system in which computer 12 comprises the server, and each user device 28A-B comprises a client. FIGS. 3 and 4 show illustrative method steps performed at the server (FIG. 3) and at each client (FIG. 4) according to one embodiment of the invention. As shown in FIG. 3, in step S1, each user interface element is configured by configuration system 38 to incorporate use data (i.e., use count and use weight). In step S2, a group of users is defined and associated with the server (i.e., computer 12). In step S3, communication system 36 obtains a use count from each user 26A-B (i.e., each user device 28A-B) and provides the use counts to calculation system 34 for processing. In step S4, calculation system 34 calculates the use weight for each user interface element, and communication system 36 communicates the use weights to each user 26A-B (i.e., each user device 28A-B) in step S5.

Turning to each client as depicted in FIG. 4, recordation systems 42A-B record a use count for each user 26A-B in step D1. In step D2, each recordation system 42A-B communicates the use count to the associated server (i.e., computer 12) and resets the use count. In step D3, modification system 44 requests a use weight from the server, and in step D4, obtains the use weight from the server. In step D5, modification system 44 modifies the user interface element based on the use weight.

It is understood that numerous variations can be incorporated in the present invention. For example, use weights can be calculated based on a series of selections. In this case, recordation system 42 would also record the order that user interface elements are selected. When user interface elements are frequently selected in a certain order, the user interface elements can be modified accordingly. Further, modification system 44 may incorporate a use weight for each user 26A-B. When a use weight for a given user 26A-B is substantially different than the use weight for the group of users, modification system 44 can select to use the use weight of the particular user 26A-B rather than the use weight for the group of users.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of customizing a user interface, the method comprising:
recording a use count for a user interface element for each user in a group of users;
obtaining a use weight for the user interface element based on the use counts for the group of users; and
modifying the user interface element for each user in the group of users based on the use weight.

2. The method of claim 1, further comprising:
defining the group of users to include a plurality of users; and
associating a server with the group of users.

3. The method of claim 2, further comprising:
obtaining the use count from each user at the server; and
resetting the use count for each user.

4. The method of claim 2, further comprising requesting the use count from each user.

5. The method of claim 2, further comprising obtaining the use weight from the server at each user.

6. The method of claim 2, further comprising requesting the use weight from the server during initialization of the application.

7. The method of claim 1, wherein the use weight comprises one of: a neutral value, a positive likelihood value, and a negative likelihood value.

8. The method of claim 7, wherein the use weight comprises a byte.

9. The method of claim 1, further comprising configuring the user interface element to incorporate use data.

10. A method of customizing a user interface, the method comprising:
defining a group of users to include a plurality of users;
associating a server with the group of users;
obtaining a use count for a user interface element for each user in the group of users at the server;
calculating a use weight for the user interface element based on the use counts for the group of users at the server; and
modifying the user interface element for each user in the group of users based on the use weight.

11. The method of claim 10, further comprising:
recording the use count at a user device for each user;
communicating the use count from each user device to the server; and
communicating the use weight from the server to each user device.

12. A system for customizing a user interface, the system comprising:
a definition system for defining the group of users;
a communication system for obtaining a use count for a user interface element for each user in a group of users; and
a calculation system for calculating a use weight for the user interface element based on the use counts for the group of users.

13. The system of claim 12, further comprising a modification system for modifying the user interface element for each user in the group of users based on the use weight.

14. The system of claim 12, further comprising a recordation system for recording the use count for each user.

15. The system of claim 12, further comprising a configuration system for configuring the user interface element to incorporate use data.

16. The system of claim 12, wherein the communication system further communicates the use weight to a user device for each user.

17. A program product stored on a recordable medium for customizing a user interface, which when executed comprises:
program code for defining the group of users;
program code for obtaining a use count for a user interface element for each user in a group of users; and
program code for calculating a use weight for the user interface element based on the use counts for the group of users.

18. The program product of claim 17, further comprising program code for modifying the user interface element for each user in the group of users based on the use weight.

19. The program product of claim 17, further comprising program code for recording the use count for each user.

20. The program product of claim 17, further comprising program code for configuring the user interface element to incorporate use data.
